(19) United States
(12) Patent Application Publication
(10) Pub. No.: US 2003/0117258 A1
(43) Pub. Date: Jun. 26, 2003

(54) Thin film chip resistor and method for fabricating the same

(75) Inventors: Young Min Kim, Kyungki-do (KR); Young Chul Shin, Seoul (KR); Hae Youn Hwang, Suwon (KR)

Correspondence Address: LOWE HAUPTMAN GOPSTEIN GILMAN & BERNER, LLP, Suite 310, 1700 Diagonal Road, Alexandria, VA, 22314, US

(73) Assignee: Samsung Electro-mechanics Co., Ltd.

(21) Appl. No.: 10/211,271

(22) Filed: Aug. 5, 2002

(30) Foreign Application Priority Data
Dec. 20, 2001 (KR) 2001-82102

(51) Int. Cl. H01C 1/012

(52) U.S. Cl. 338/309

(57) ABSTRACT

Disclosed is a thin film chip resistor having a structure suitable for effectively utilizing a slit substrate and simplifying a thin film forming step, in which thick film electrodes are formed on upper and lower surfaces of an insulator substrate, the thin film resistive layer is formed between thick film electrodes, and thin film electrodes connected to the thin film resistive layer are formed on both side portions of the upper surface of the insulator substrate. Furthermore, provided is a method for fabricating the thin film chip resistor, which can omit the step of forming thin film on a lower surface of the insulator substrate and minimize a defective proportion, which may occur during parting the insulator substrate along slits, by securing a space sufficient for contacting to probes with electrodes in a laser trimming step.

### BACKGROUND OF THE INVENTION

1. Field of the invention

The present invention relates, in general, to a thin film chip resistor and a method for fabricating the same and, in particular, to a thin film chip resistor having a structure suitable for effectively utilizing an insulator substrate with a plurality of slits formed at predetermined intervals in rows and columns and simplifying a thin film forming step, and a method for fabricating the thin film chip resistor.

2. Description of the Prior Art

Generally, a chip resistor used in an electronic apparatus is classified into a thick film chip resistor and a thin film chip resistor according to the thickness of a resistive layer. In particular, the thin film chip resistor is more excellent in a temperature coefficient of resistance (TCR), which is a most important physical property required in using as a resistance, than the thick film chip resistor. That is to say, it is difficult to obtain a TCR value of 100 ppm or less from the thick film chip resistor owing to a material's characteristic. However, for the thin film chip resistor, the TCR value of about 0 ppm can be obtained. Furthermore, the thin film chip resistor can maintain the deviation of 0.1% or less, while the thick film chip resistor has a resistance value deviation ranging from 1 to 5% owing to a thick resistive layer and calcination process of an electrode.

Accordingly, the thin film chip resistor is suitable for realizing a precision resistance, and demands for thin film chip resistors are growing as the field of digital equipment such as MP3 players, camcorders, and digital cameras grows.

The thin film chip resistor is provided with a thin film resistive layer formed from materials such as NiCr by using a sputtering process or deposition process. Like the thick film chip resistor, the thin film chip resistor has a resistive layer formed on an upper surface of an insulator substrate, and a “⊂”-shaped lateral terminal connected to the resistive layer, formed on opposing side faces of the insulator substrate. But, application of a thin film process technology and use of a high purity alumina substrate allow the thin film chip resistor to have various structures.

In order to better understand the background of the present invention, a description will be given below of a conventional chip-formed solid electrolytic capacitor.

FIG. 1 is a sectional view of a conventional thin film chip resistor.

With reference to FIG. 1, a thin film resistive layer 15 covers the upper surface, both sides, and a portion of the lower surface of the insulator substrate 11, and a thin film electrode 16 is formed to cover both side portions of the thin film resistive layer 15 on the upper surface of the insulator substrate 11 to the thin film resistive layer 15 formed on the lower surface of the insulator substrate. A plating layer 19 is formed on the thin film electrode 16, and a protective layer 17 is formed on the upper surface of the thin film resistive layer 15.

FIG. 2 is a flow chart illustrating fabrication of the thin film chip resistor in FIG. 1.

Referring to FIG. 2, after forming thin film resistive layers on the whole upper surface and on both side portions of the lower surface of the insulator substrate by a sputtering process, thin film resistive layers are patterned by a photolithography and etching process in step 110. Thin film electrodes are then formed on both side portions of thin film resistive layers formed on the upper surface of the insulator substrate and on thin film resistive layers formed on the lower surface of the insulator substrate by a sputtering process, which are desirably patterned by a photolithography and etching process in step 120.

The resulting structure suffers heat treatment to stabilize a resistance value, and through the laser trimming process there is provided a precision resistance value to the resulting structure in step 130. Next, a protective layer for protecting the thin film resistive layer is printed and cured through a typical thick film forming process, then the resulting insulator substrate is primarily diced so as to form the opposing side faces of the insulator substrate to an atmosphere in step 140. Lateral electrodes are then formed on the opposing side faces of the insulator substrate through the sputtering process in the same manner as the formation of the thin film resistive layer and the thin film electrode in step 150. The resulting insulator substrate is secondly diced into chips in step 160, and is plated with an alloy of Ni and Pd—Sn to produce final products in step 170.

As described above, a conventional method for fabricating the thin film chip resistor requires the steps of forming the thin film on an upper surface, a lower surface, and opposing side face of the insulator substrate. These thin films are formed by a very complicated process such as the sputtering process, the photolithography process and the etching process, in comparison with thick films formed by the screen printing process.

In addition, when the insulator substrate is parted into chips, a conventional high purity alumina substrate for a thin film is difficult to part by a conventional dicing process because the substrate has a high strength. The insulator substrate then requires a special blade or laser to be parted. Therefore, the process is complicated and production cost is increased.

However, the thick film chip resistor can avoid the above disadvantages by using a slit substrate. This slit substrate is an insulator substrate, on the upper and lower surfaces of which slits are formed at predetermined intervals in rows and columns. The slit substrate has an advantage in that the substrate can be easily parted into chips by applying a pressure into the substrate. However, the slit substrate also has various problems to be applied to the thin film chip resistor.

With reference to FIGS. 3a and 3b, the insulator substrates 31, 31′, on the slits of which electrodes are formed, are illustrated. In FIG. 3a, thick film electrodes 33 are formed on slits positioned at both sides of the thick film resistive layer 35, like the thick film chip resistor. Thick film electrodes 33 range from 5 to 10 μm in thickness, so that thick film electrodes can be sufficiently filled in slits and form layers having a predetermined width W1.

On the other hand, in FIG. 3b, thin film electrodes 36 are formed on slits positioned at both sides of the thin film resistive layer 35′. Thin film electrodes cannot be sufficiently filled in slits because the thin film electrode is less than 1 μm in a thickness. Therefore, in FIG. 3a, a space of the thick film electrode, to which probes 30 are contacted, is sufficiently secured during a laser trimming step, which is an important step in forming a required resistive layer. However, in FIG. 3b, the space W2 of the thin film electrode, to which probes 30 are contacted, is too small to accomplish the laser trimming step. In the case of a small chip, in particular, the small space of the thin film electrode, to which probes are contacted, is very fatal because a terminal electrode is very small.

In addition, the thin film electrode on the upper surface of the insulator substrate may be opened in a partition step, and electrode residues in slits formed on the lower surface of the insulator substrate are continuously connected to each other in a plating step, so that the resistance is reduced. For these reasons, the thin film chip resistor is not frequently fabricated with the use of the slit substrate of FIG. 3 even though the insulator substrate can be easily parted to chips.

Therefore, there is a need for a thin film chip resistor having a structure suitable for effectively utilizing a slit substrate for easily parting the substrate and simplifying a thin film forming step, and a method for fabricating the thin film chip resistor having advantages in that a laser trimming step is smoothly conducted and an open or short is prevented.

### SUMMARY OF THE INVENTION

Therefore, it is an object of the present invention to avoid disadvantages of prior arts, and to provide a thin film chip resistor having a structure suitable for effectively utilizing a slit substrate and simplifying a thin film forming step, in which thick film electrodes are formed on upper and lower surfaces of an insulator substrate, a thin film resistive layer is formed between thick film electrodes, and thin film electrodes connected to the thin film resistive layer are formed on both side portions of the upper surface of the insulator substrate.

It is another object of the present invention to provide a method for fabricating a thin film chip resistor, comprising the steps of forming thick film electrodes for filling slits formed on an upper and lower surfaces of an insulator substrate; forming a thin film resistive layer on the upper surface of the insulator substrate; and forming thin film electrodes connected to the thin film resistive layer on both side portions of the upper surface of the insulator substrate. The method can omit a step of forming thin film on the lower surface of the insulator substrate and minimize a defective proportion, which may occur during parting the insulator substrate along slits, by securing a space sufficient for contacting to probes with electrodes in a laser trimming step.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view of a conventional thin film chip resistor;

FIG. 2 is a flow chart illustrating fabrication of the conventional thin film chip resistor;

FIGS. 3a and 3b are sectional views of an insulator substrate, on which electrodes are formed along slits;

FIG. 4 is a sectional view of the thin film chip resistor according to an embodiment of the present invention; and

FIGS. 5a to 5h are sectional views illustrating stepwise fabrication of a thin film chip resistor according to a present invention.

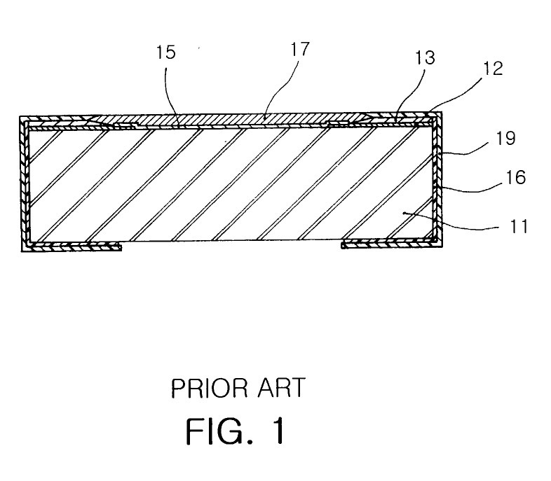

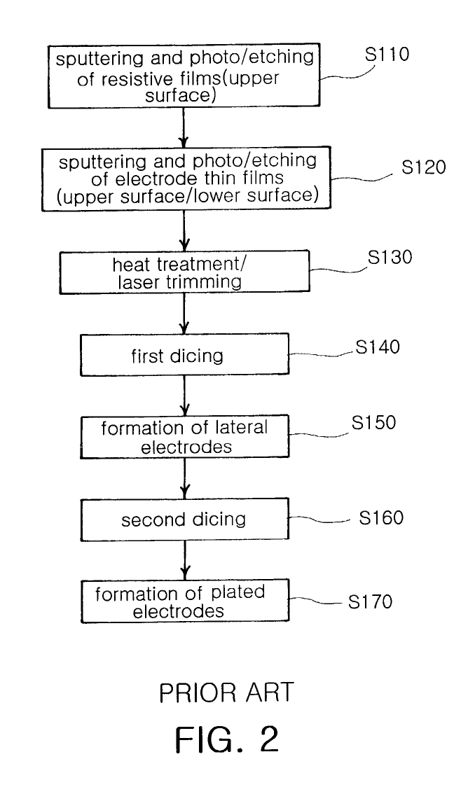

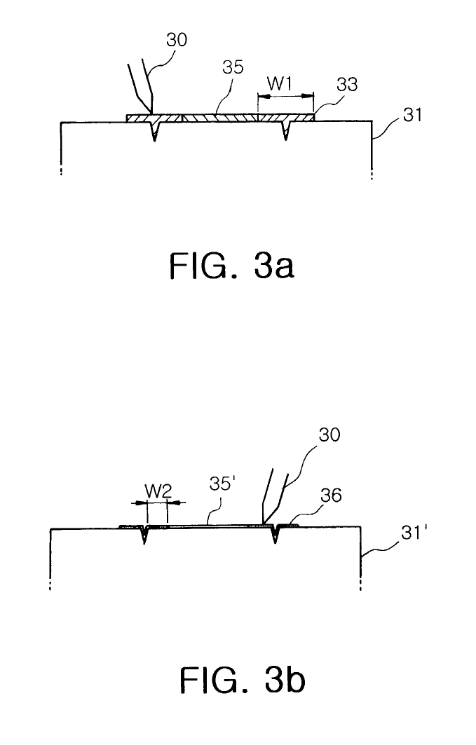

### DETAILED DESCRIPTION OF THE INVENTION

The present invention provides a thin film chip resistor comprising a chip-type insulator substrate; thick film electrodes formed on both side portions of an upper and an lower surface of the insulator substrate; a thin film resistive layer formed on the upper surface of the insulator substrate; thin film electrodes formed on both side portions of the upper surface of the insulator substrate in such a way as to be in contact with the thin film resistive layer; lateral terminal electrodes formed on opposing side faces of the insulator substrate; and electrodes plated at both sides of the insulator substrate, each covering the thin film electrode on the upper surface of the insulator substrate, the lateral terminal electrode, and the thick film electrode on the lower surface of the insulator substrate.

According to an embodiment of the present invention, the thin film chip resistor further comprises a protective layer for protecting the thin film resistive layer, which is formed between plated electrodes formed on the upper surface of the insulator substrate. The protective layer is preferably made of a polymer material with a low curing temperature.

Furthermore, the thin film resistive layer may wholly cover the upper surface of the insulator substrate, on which thick film electrodes are formed, or may be separated from thick film electrodes formed on the upper surface of the insulator substrate.

Meanwhile, the present invention provides a method for fabricating a thin film chip resistor, comprising the steps of providing an insulator substrate on which plural slits are formed at predetermined intervals in rows and columns; constructing thick film electrodes along the slits in column on the upper and lower surfaces of the insulator substrate; depositing a thin film resistive layer on the upper surface of the insulator substrate; forming thin film electrodes on the thick film electrodes in such a way as to contact with the thin film resistive layer; primarily parting the insulator substrate along slits in row; forming a lateral terminal electrode on each opposing side face of the parted insulator substrate; secondly parting the insulator substrate along slits in column into individual chips; and plating an electrode at each side of the insulator substrate of the chip in such a way that the electrode covers the thin film electrode on the upper surface of the insulator substrate, the lateral terminal electrode, and the thick film electrode on the lower surface of the insulator substrate.

In addition, the method for fabricating the thin film chip resistor according to the present invention further comprises the step of treating an upper surface of the insulator substrate in order to improve the roughness of the upper surface so that the insulator substrate is used as an insulator substrate for a thick film.

Furthermore, the method of the present invention may further comprise the step of forming a protective layer on the thin film resistive layer before lateral terminal electrodes are formed and after the thin film resistive layer is formed.

The present invention may be understood more readily by reference to the following detailed description of preferred embodiments of the invention and the figures.

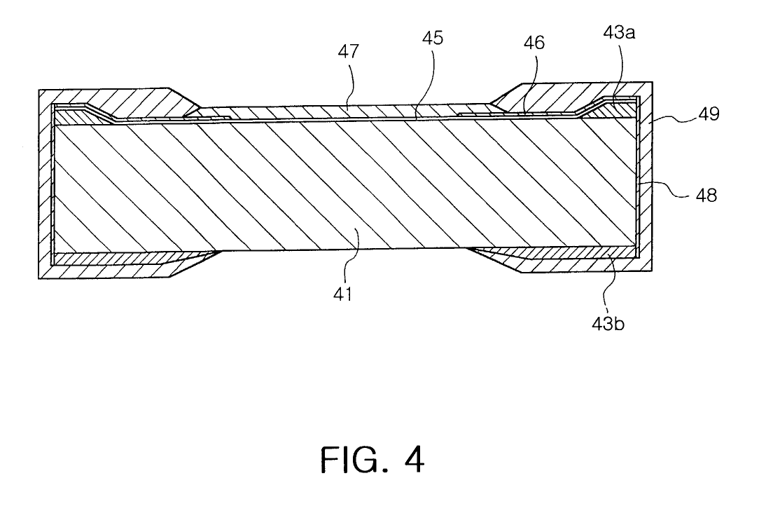

FIG. 4 is a schematic sectional view of the thin film chip resistor according to an embodiment of the present invention. Different structures are formed on an upper surface, lower surface, and opposing side faces of a chip type insulator substrate 41. Thick film electrodes 43a, a thin film resistive layer 45, thin film electrodes 46, and a protective layer 47 are formed on an upper surface of the insulator substrate 41.

In practice, thick film electrodes 43a are printed on such a position of the insulator substrate as to fill the slits. In the structure of FIG. 4 after the partition of the insulator substrate, the thick film electrodes are positioned on both side portions of the upper surface of the insulator substrate 41. The thick film electrodes 43a must be thick enough to completely fill the slits. In the present invention, the thickness of the thick film electrodes 43 are as large as 10 μm. Therefore, the space where probes can be contacted with electrodes in a subsequent trimming process is sufficiently secured. Furthermore, the thin film resistive layer 45 is formed in a thickness of 300 to 1000 Å on the upper surface of the insulator substrate by a sputtering process or a deposition process. The thin film resistive layer 45 is formed on the whole upper surface of the insulator substrate comprising thick film electrodes 43a, as shown in FIG. 4. It is difficult to form a continuous incline with the thin film resistive layer 45 because the thin film resistive layer is 200 times thinner than the thick film electrode 43a, and so the thin film resistive layer may be not electrically connected to the thick film electrode. However, thin film electrodes 46 are thoroughly electrically connected to the thin film resistive layer and have a relatively thick thickness, so that there is not any problem in connecting the thin film electrode to the thick film electrode.

Meanwhile, the thin film resistive layer may be formed only within a region between thick film electrodes, contrary to the embodiment of FIG. 4.

The thin film resistive layer 45 may not be connected to thick film electrodes 43a, but should be inevitably connected to thin film electrodes 46 formed on both side portions of the upper surface of the insulator substrate 41. Therefore, a resistance value of the thin film resistive layer 45 can be precisely controlled by contacting probes to thin film electrodes 46 in a laser trimming process, and terminals can be formed by plated electrodes 49 covering thin film electrodes 46. At this time, slits are thoroughly filled by thick film electrodes 43a, so that thin film electrodes 46 overlapped on thick film electrodes 43a have a sufficient space to contact with probes.

Finally, a protective layer 47 is formed on the resulting insulator substrate. The protective layer 47 is preferably made of a polymer material with a low curing temperature.

Meanwhile, thick film electrodes 43b are also formed on both side portions of the lower surface of the chip type insulator substrate 41. Accordingly, the thin film chip resistor can be fabricated by easily forming thick film electrodes 43b by a screen printing process without forming the unnecessary thin film electrode, which is accompanied by a complicated thin film forming process.

In addition, thin films having an excellent adhesive property are attached to opposing side faces of the chip type insulator substrate to form lateral terminal electrodes 48. The lateral terminal electrode fills a role of a preliminary layer for smoothly forming a plated electrode, as well as provides a framework for forming a [-shaped terminal connecting the thin film electrode 46 to the thick film electrode 43b. Plated electrode 49 are formed on lateral terminal electrodes by a barrel plating process to complete lateral terminals.

A detailed description will be given of a method for fabricating a thin film chip resistor in order to better understand constitutional characteristics of the present invention.

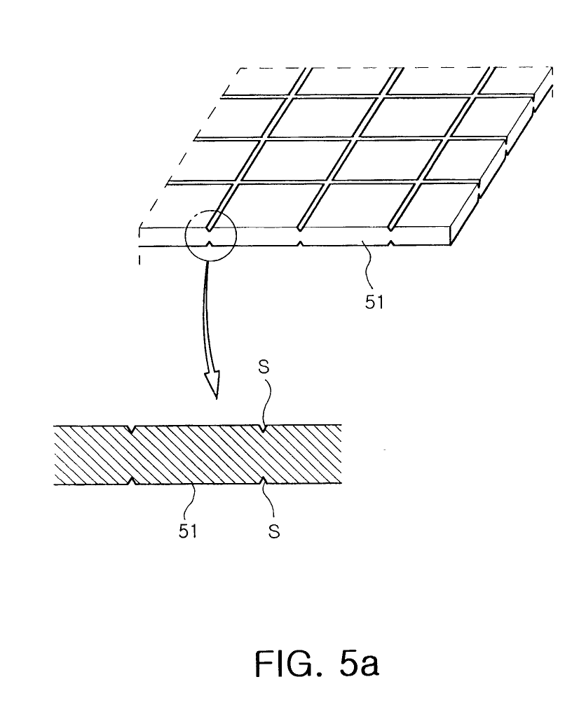

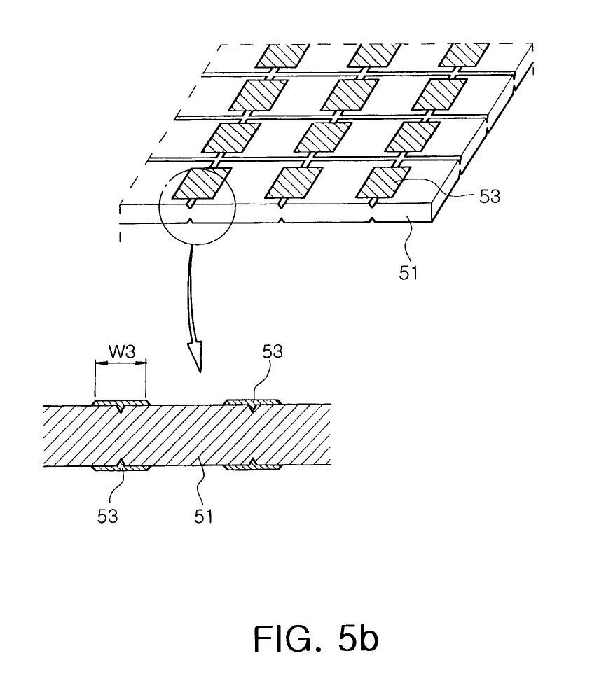

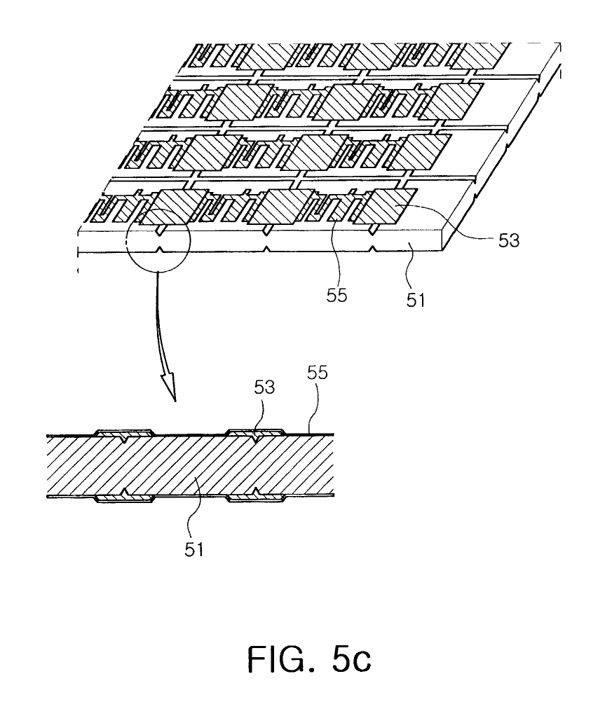

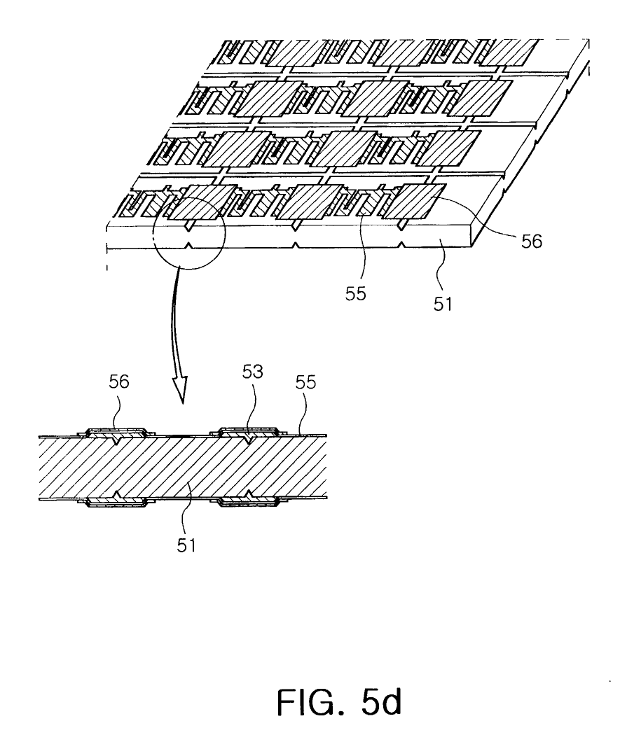

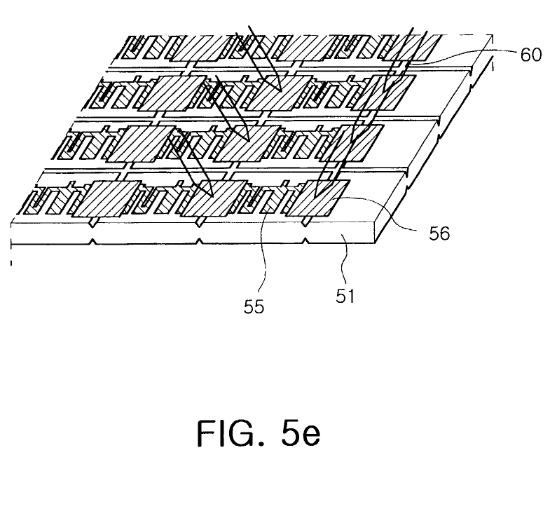

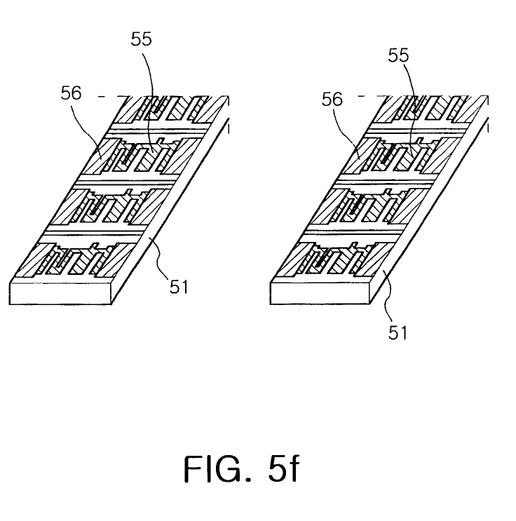

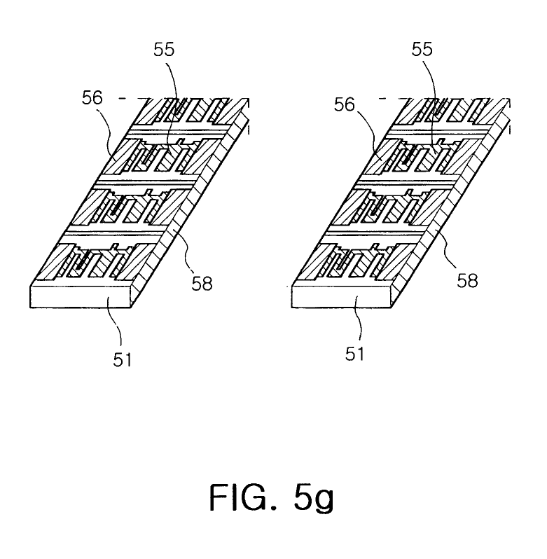

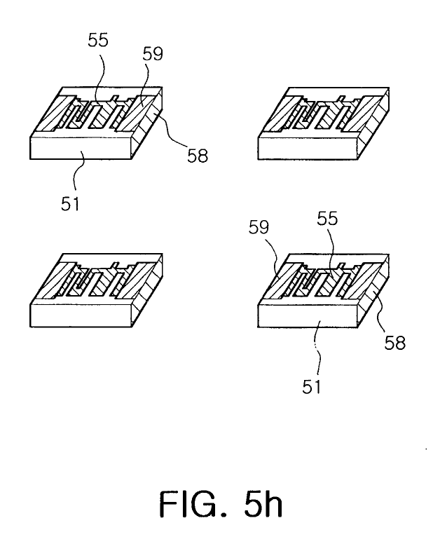

FIGS. 5a to 5g are schematic cross sectional views illustrating stepwise fabrication of a thin film chip resistor according to a present invention.

With reference to FIG. 5a, plural slits are formed at predetermined intervals in rows and columns on the insulator substrate 51. A surface of a chip depends on the interval between slits. The insulator substrate can be parted along slits to form chips, and so the method for fabricating the thin film chip resistor of the present invention does not require a dicing process with the use of a blade and a parting process with the use of a laser.

Generally, a slit substrate for the thick film may be used as the slit substrate. However, in the case of using the slit substrate for the thick film, it is preferable to improve surface roughness by conducting a surface treatment so as to form the thin film resistance. For example, the surface roughness Ra of the slit substrate for the thick film is 3000 Å, which is more rough than that of the slit substrate for the thin film (500 to 600 Å). But the surface roughness of the slit substrate for the thick film can be improved from 1000 to 1500 Å, at which point the thin film can be formed, by the chemical surface treatment. Therefore, this method is advantageous in that production cost is reduced by substituting the insulator substrate for the thin film with a low-priced slit substrate for the thick film.

Referring now to FIG. 5b, thick film electrodes are formed so as to contain slits in column on the upper and lower surface of the insulator substrate 51. The thick film electrode is made of Ag paste or Ag—Pd paste, which has excellent plating property and an adhesive property, and so the thick film electrode can be formed on the substrate 51 without a thin film. The thick film electrode is formed in a thickness suitable for filling slits, so that the probes contacting space for trimming can be sufficiently secured. Furthermore, the thick film electrode is formed at 850° C. by a screen printing process, which is a simpler process than a thin film forming process. Such thick film electrodes 53 are formed on the upper and lower surface of the insulator substrate, and additional films are not formed on the lower surface of the insulator substrate.

Turning to FIG. 5c, the thin film resistive layer 55 is formed on the upper surface of the insulator substrate 51. The thin film resistive layer 55 is formed from any one selected from the group consisting of NiCr, CuNi, CrSi, and an alloy thereof by the sputtering process or the deposition process, and is patterned with the use of a metal mask or by a photolithography and etching process. The thin film resistive layer 55 is formed in a thickness of 300 to 1000 Å, which may be varied according to a required resistance value, and physical properties of the thin film resistive layer may be varied by modifying the crystal structure of the layer through a heat treatment process.

With reference to FIG. 5d, thin film electrodes 56 are formed on both side portions of the upper surface of the insulator substrate 51 so as to connect to the thin film resistive layer 55. Although they thin film electrodes are laid overlapping slits, they can be formed over a sufficiently large region because the thick film electrodes already fill the slits. Hence, a space where the probes 60 can be contacted with the electrodes in the laser trimming process can be secured, as shown in FIG. 5e.

After the processes of FIGS. 5a to 5e, the insulator substrate 51 is primarily parted along slits in rows, as shown in FIG. 5f. The opposing side faces of the parted insulator substrate 51 are exposed to an atmosphere.

Referring to FIG. 5g, lateral terminal electrodes 58 are formed on the side faces of the parted insulator substrate. Lateral terminal electrodes 58 connect thin film electrodes and thick film electrodes on the upper surface of the insulator substrate with thick film electrodes on the lower surface of the insulator substrate to form a [-shaped terminal. Lateral terminal electrodes may be formed by various processes. The thick film may be formed from Ag paste for which is used at a low temperature. But the thick film may be generally formed by continuously laminating NiCr, Cr, or Ti films have excellent adhesive properties and a Cu film which has excellent plating properties and conductivity by a conventional thin film forming process. Furthermore, the thick film may be formed in only one layer made of materials which have excellent adhesive and plating properties, for example, NiCr or NiCu alloy.

Turning now to FIG. 5h, the parted insulator substrate is secondly parted along slits in rows, and plated to form plated electrodes 59 covering both side portions of the upper and lower surfaces of the insulator substrate as well as the opposing side faces of the insulator substrate. Plated electrodes 59 are made of any one selected from the group consisting of Ni—Sn, Cu—Ni—Sn, Ni—SnPb, or Cu—Ni—SnPb. Whereby, the resulting thin film chip resistor is obtained.

A method for fabricating the thin film chip resistor according to FIGS. 5a to 5h may be modified, if necessary. The method may further comprise a surface treatment step for improving surface roughness of the upper surface of the insulator substrate, or the step of forming a protective layer on the thin film resistive layer before the lateral terminal electrode is formed and after the thin film resistive layer is formed.

As described above, the present invention has advantages in that a complicated process can be omitted, in which a thin film is formed on a lower surface of an insulator substrate, by forming thick film electrodes for filling slits formed on upper and lower surfaces of the insulator substrate, and forming a thin film resistive layer on the upper surface of the insulator substrate and then forming thin film electrodes, which are connected to the thin film resistive layer, on both side portions of the upper surface of the insulator substrate. Also the present invention provides a thin film chip resistor and a method for fabricating the thin film chip resistor, which can secure a space sufficient to contact probes to electrodes and minimize the defective proportion in a partition step utilizing slits.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A thin film chip resistor comprising:
a chip-type insulator substrate;
thick film electrodes formed on both side portions of an upper and an lower surface of the insulator substrate respectively;
a thin film resistive layer formed on the upper surface of the insulator substrate;
thin film electrodes formed on both side portions of the upper surface of the insulator substrate to connect with the thin film resistive layer;
lateral terminal electrodes formed on both side faces of the insulator substrate; and
plating electrodes formed at both side faces of the insulator substrate, each extending to the thin film electrode and the thick film electrode.

2. The thin film chip resistor according to claim 1, further comprising a protective layer for protecting the thin film resistive layer, said protective layer being formed between plated electrodes formed on the upper surface of the insulator substrate so as to cover the thin film resistive layer.

3. The thin film chip resistor according to claim 2, wherein the protective layer is made of a polymer material with a low curing temperature.

4. The thin film chip resistor according to claim 1, wherein the thin film resistive layer wholly covers the upper surface of the insulator substrate, on which the thick film electrode is formed.

5. The thin film chip resistor according to claim 1, wherein the thin film resistive layer is separated from thick film electrodes formed on the upper surface of the insulator substrate.

6. The thin film chip resistor according to claim 1, wherein thick film electrodes are made of Ag paste or Ag—Pd paste.

7. The thin film chip resistor according to claim 1, wherein the thin film resistive layer is one selected from the group consisting of NiCr, CuNi, CrSi, and an alloy thereof.

8. The thin film chip resistor according to claim 1, wherein lateral terminal electrodes are formed by laminating a film composed of one selected from the group consisting of NiCr, Cr, Ti, and an alloy thereof, and other film composed of Cu.

9. The thin film chip resistor according to claim 1, wherein lateral terminal electrodes are films composed of one selected from the group consisting of NiCr, NiCu, and an alloy thereof.

10. The thin film chip resistor according to claim 1, wherein lateral terminal electrodes are made of Ag paste or Ag—Pd paste.

11. The thin film chip resistor according to claim 1, wherein plated electrodes are films composed of one selected from the group consisting of Ni—Sn, Cu—Ni—Sn, Ni—SnPb, or Cu—Ni—SnPb.

12. A method for fabricating a thin film chip resistor, comprising the steps of:
providing an insulator substrate on which plural slits are formed at predetermined intervals in rows and columns;
constructing thick film electrodes along the slits in column on the upper and lower surfaces of the insulator substrate;
depositing a thin film resistive layer on the upper surface of the insulator substrate;
forming thin film electrodes on the thick film electrodes to connect with the thin film resistive layer;
primarily parting the insulator substrate along slits in row;
forming lateral terminal electrodes on opposing side faces of the parted insulator substrate respectively;
secondly parting the insulator substrate along slits in column into individual chips; and
forming plating electrodes at the lateral terminal electrodes, which extend to the thin film electrode and the thick film electrode.

13. The method according to claim 12, further comprising the step of treating the upper surface of the insulator substrate for improving surface roughness of the upper surface.

14. The method according to claim 12, further comprising the step of forming a protective layer on the thin film resistive layer before the insulator substrate is primarily parted and after thin film electrodes are formed.

15. The method according to claim 12, further comprising the step of heat treating the resulting insulator substrate for stabilizing a resistance value of the thin film resistive layer before the insulator substrate is primarily parted and after thin film electrodes are formed.

16. The method according to claim 12, further comprising the step of trimming the thin film resistive layer before the insulator substrate is primarily parted and after thin film electrodes are formed.

17. The method according to claim 12, wherein said thick film electrodes are formed by printing and curing Ag paste or Ag—Pd paste with the use of a screen printing process.

18. The method according to claim 12, wherein said lateral terminal electrodes are formed on both flanks of the parted insulator substrate by printing and curing Ag paste or Ag—Pd paste with the use of a screen printing process.

19. The method according to claim 12, wherein said lateral terminal electrodes are formed on both flanks of the parted insulator substrate by a sputtering process or a deposition process.

20. The method according to claim 12, wherein the step of forming plated electrodes is conducted by a barrel plating process.
